(19) United States
(12) Patent Application Publication
(10) Pub. No.: US 2025/0374077 A1
(43) Pub. Date: Dec. 4, 2025

(54) IDENTIFYING NETWORK NODE CAUSING VOICE ACCESS FAILURE

(71) Applicant: T-MOBILE INNOVATIONS LLC, Overland Park, KS (US)

(72) Inventors: Maria Victoria CABAMALAN, Covington, WA (US); Joseph Amagna SANTOR, Renton, WA (US); Jonathan Sarbillon RAMIREZ, Little Elm, TX (US); John Barry Santiago LAZARTE, Tukwila, WA (US)

(21) Appl. No.: 18/676,176

(22) Filed: May 28, 2024

(51) Int. Cl. H04W 24/02; H04L 41/5009; H04L 65/1045; H04W 60/04

(52) U.S. Cl. CPC H04W 24/02; H04L 41/5009; H04L 65/1045; H04W 60/04

(57) ABSTRACT

At a high level, the technology disclosed herein relates to network node anomaly detection using one or more network node anomaly detection machine learning models. In embodiments, Key Performance Indicator associated with voice call establishment (e.g., for Voice over New Radio, Evolved Packet System Fallback, etc.) may be received. Key Performance Indicator of particular network node data associated with the voice call establishment may be provided to the one or more network node anomaly detection machine learning models (e.g., a density function machine learning model) for anomaly detection. In embodiments, the particular network node data may correspond to control plane nodes, such as an Access and Mobility Management Function (AMF), User Plane Function (UPF), Policy Control Function (PCF), Session Management Function (SMF), etc. An indication of the control plane node identified based on time and location correlation via the anomaly detection may be provided.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for identifying network node(s) causing voice access failure. For example, in embodiments, a trigger associated with voice call establishment (e.g., Voice over New Radio, Evolved Packet System Fallback, etc.) may be received for the network node anomaly detection. Based on the trigger, particular network node data associated with the voice call establishment to one or more network node anomaly detection machine learning models. For example, the one or more network node anomaly detection machine learning models may include a density function machine learning model (e.g., a Gaussian Mixture Model, a Deep Generative Model, etc.) for evaluation of a plurality of key performance indicators associated with control plane nodes.

In embodiments, the plurality of key performance indicators associated with the control plane nodes may include Access and Mobility Management Function (AMF) registration network node data associated with an AMF control plane node and the voice call establishment, AMF Packet Data Unit (PDU) establishment network node data associated with the AMF control plane node and the voice call establishment, User Plane Function (UPF) Session Initiation Protocol (SIP) invite network node data associated with a UPF control plane node and the voice call establishment, Policy Control Function (PCF) Authorization Authentication Request (AAR) network node data associated with a PCF control plane node and the voice call establishment, Session Management Function (SMF) network node data corresponding to voice call establishment communications between an SMF control plane node and each of the AMF control plane node and the UPF control plane node, AMF PDU session resource modification network node data associated with the AMF control plane node and the voice call establishment, AMF Tracking Area Update (TAU) network node data associated with the AMF control plane node and the voice call establishment, AMF Next Generation Application Protocol (NGAP) reset network node data associated with the AMF control plane node and the voice call establishment, AMF paging network node data associated with the AMF control plane node and the voice call establishment, etc., or one or more combinations thereof.

In embodiments, the one or more network node anomaly detection machine learning models may be used to identify a control plane node having anomalous network node data (e.g., based on providing the plurality of key performance indicators in a particular order, based on particular clusters of the plurality of key performance indicators, based on historical key performance indicators for each of the control plane nodes, etc., or one or more combinations thereof). In some embodiments, an indication of the control plane node having anomalous network node data may be provided. In some embodiments, information as to why the voice call was not established.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for utilizing a network node anomaly detection engine, in accordance with embodiments herein;

FIG. 2 depicts an example network block diagram for network node anomaly detection, in accordance with embodiments herein;

FIGS. 3A-3C illustrate an example block diagram for operations associated with the network node components for utilizing a network node anomaly detection engine to identify a control plane node, in accordance with embodiments herein;

FIG. 4 depicts example tables associated with the network node anomaly detection using the network node anomaly detection engine, in accordance with embodiments herein;

FIG. 5 depicts an example indication for the control plane node having the anomalous network node data, in accordance with embodiments herein;

FIG. 6 depicts an example flowchart for network node anomaly detection, in accordance with embodiments herein; and

FIG. 7 depicts an example user device and example user device functionality associated with the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, voice access in 5G standalone technologies can be established as Voice over New Radio (VoNR) or Evolved Packet System Fallback (EPSFB) (e.g., via handover or redirect). Different 5G core network functions play various roles in establishing a voice call. Challenges is detecting specifically where within the radio access network or core network that caused the voice call to result in failure. For example, different vendors associated with the radio access network or core network may implement different standards, which may cause interruptions in establishing VoNR or EPSFB. As another example, during handover between network technologies, factors such as signal degradation, network congestion, insufficient network coverage, etc., may play a role in causing the failure of establishing VoNR or EPSFB. In yet another example, Quality of Service (QoS) metrics, such as latency, jitter, packet loss, etc., may cause network conditions or resource limitations that affect the establishment of VoNR or EPSFB. Previous relevant technologies have been unable to determine where within the radio access network or core network that caused a voice call failure, and why the voice call had failed (e.g., because of one or more particular QoS metrics, network congestion at a particular node, signal degradation at a particular node, insufficient coverage based on a particular node, etc.).

Embodiments of the technology discussed herein provide various improvements to these challenges discussed above. For example, the technology described herein can determine specifically where within the radio access network or core network that caused the voice call to result in failure, and these determinations can be made such that the Mean-Time-To-Detect (MTTD) is fast (e.g., during real-time or within a few minutes of real-time), and such that the Mean-Time-To Resolve (MTTR) issues of voice access failure is also fast, thereby improving user device experiences as well as radio access network and core network systems. The technology described herein can perform these operations, for example, by identifying particular key performance indicators (KPIs) that identify which control plane nodes (e.g., Access and Mobility Management Function (AMF) control plane node, User Plane Function (UPF) control plane node, Policy Control Function (PCF) control plane node, Session Management Function (SMF) control plane node, etc.) is causing the voice call failure. As an example, by analyzing & correlating particular parts of the end-to-end Voice Call Establishment call flow in a 5G Stand Alone Network, the present technology can detect Voice Access Failure & identify which node is causing the issue.

In an embodiment, a system for network node anomaly detection is provided. The system may comprise one or more processors and computer memory storing computer-usable instructions that, when executed by the one or more processors, cause the one or more processors to perform operations. The operations may comprise receiving a Key Performance Indicator (KPI) associated with voice call establishment for the network node anomaly detection. The operations may also comprise providing network node data associated with the voice call establishment to one or more network node anomaly detection machine learning models. The operations may also comprise based on the KPI and providing the network node data to the one or more network node anomaly detection machine learning modes, identifying a control plane node anomaly based on time and regional correlation. The operations may also comprise providing an indication of the control plane node anomaly.

In another embodiment, a method for network node anomaly detection is provided. The method may comprise receiving, from a user device and over a network, a Key Performance Indicator associated with establishing a voice call for the network node anomaly detection. Based on the Key Performance Indicator, network node data, associated with the voice call and a plurality of network nodes of the network, may be provided to one or more network node anomaly detection machine learning models. The method may also comprise identifying, using the one or more network node anomaly detection machine learning models, a control plane node of the plurality of network nodes having anomalous network node data. The method may also comprise providing an indication of the control plane node.

In another example embodiment, one or more computer storage media having computer-executable instructions embodied thereon, that when executed by at least one processor, cause the at least one processor to perform a method. The method may comprise receiving a Key Performance Indicator associated with voice call establishment. Based on the Key Performance Indicator, network node data associated with the voice call establishment may be provided to one or more network node anomaly detection machine learning models. The method may also comprise identifying a control plane node having anomalous network node data based on time & regional correlation. The method may also comprise causing to provide an indication of the control plane node.

### Example Operating Environments

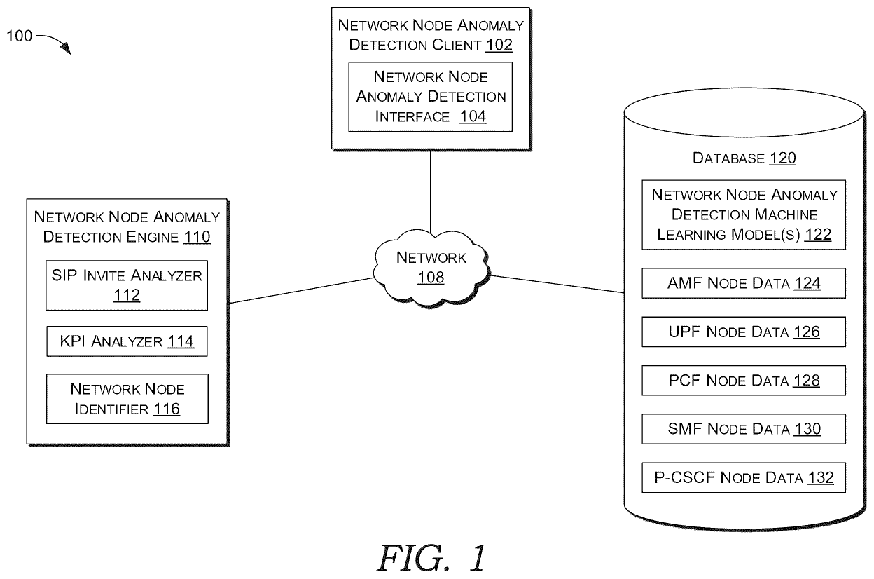

Turning now to FIG. 1, example operating environment 100 is illustrated in accordance with one or more embodiments disclosed herein. At a high level, the example operating environment 100 comprises network node anomaly detection client 102, network node anomaly detection interface 104, network 108, network node anomaly detection engine 110, and database 120. The network node anomaly detection engine 110 may comprise Session Initiation Protocol (SIP) Invite analyzer 112, KPI analyzer 114, and network node identifier 116. The database 120 may comprise network node anomaly detection machine learning model(s) 122, AMF node data 124, UPF node data 126, PCF node data 128, SMF node data 130, and P-CSCF node data 132.

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional network node anomaly detection clients or other configurations of database 120 (e.g., database 120 may be a distributed computing environment encompassing multiple computing devices for storing one or more of the node data separately).

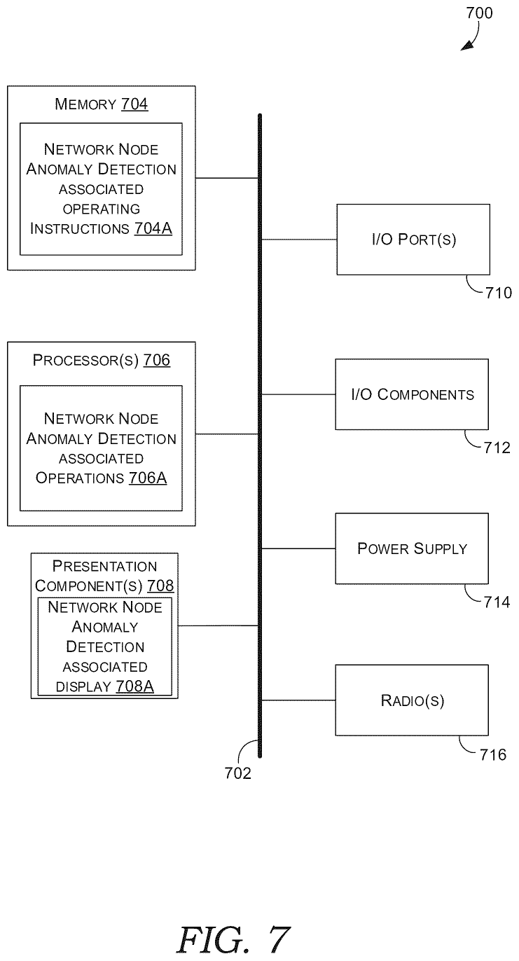

Network node anomaly detection client 102 may be a device that has the capability of communicating (e.g., transmitting or receiving one or more signals to or from) with one or more of the network node anomaly detection engine 110 and database 120 over the network 108. In some embodiments, the network node anomaly detection client 102 may be referred to as a “user device,” “computing device,” “mobile device,” “client,” “user equipment (UE),” or “wireless communication device.” The network node anomaly detection client 102, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating over the network 108. The network node anomaly detection client 102 may be, in an embodiment, user device 700 described herein with respect to FIG. 7.

In some embodiments, the network node anomaly detection client 102 may cause the display, via the network node anomaly detection interface 104, of an indication of the control plane node anomaly that the network node anomaly detection engine 110 identifies (e.g., via the network node identifier 116) as having anomalous network node data. In embodiments, the network node anomaly detection interface 104 may be the one or more presentation components 708 of FIG. 7. In embodiments, the network node anomaly detection interface 104 may display information as to why a voice call (e.g., initiated by the network node anomaly detection client 102 or another user device) was not established based on communication(s) with the network node anomaly detection engine 110. In embodiments, the network node anomaly detection interface 104 may display image data, text data, extended reality data, other types of data, or one or more combinations thereof, based on one or more of the network node anomaly detection engine 110 (e.g., operations associated with the SIP Invite analyzer 112, KPI analyzer 114, and network node identifier 116, the database 120, etc.).

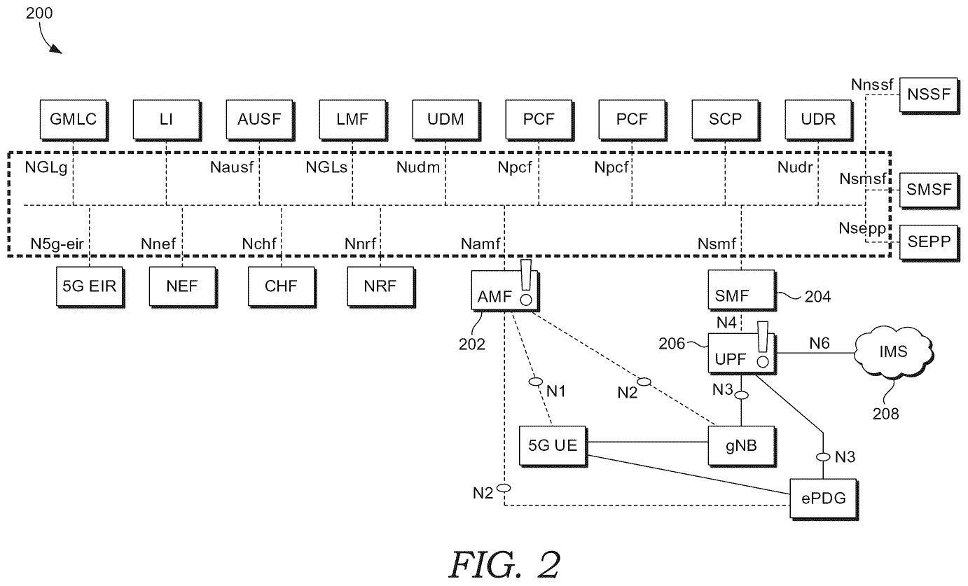

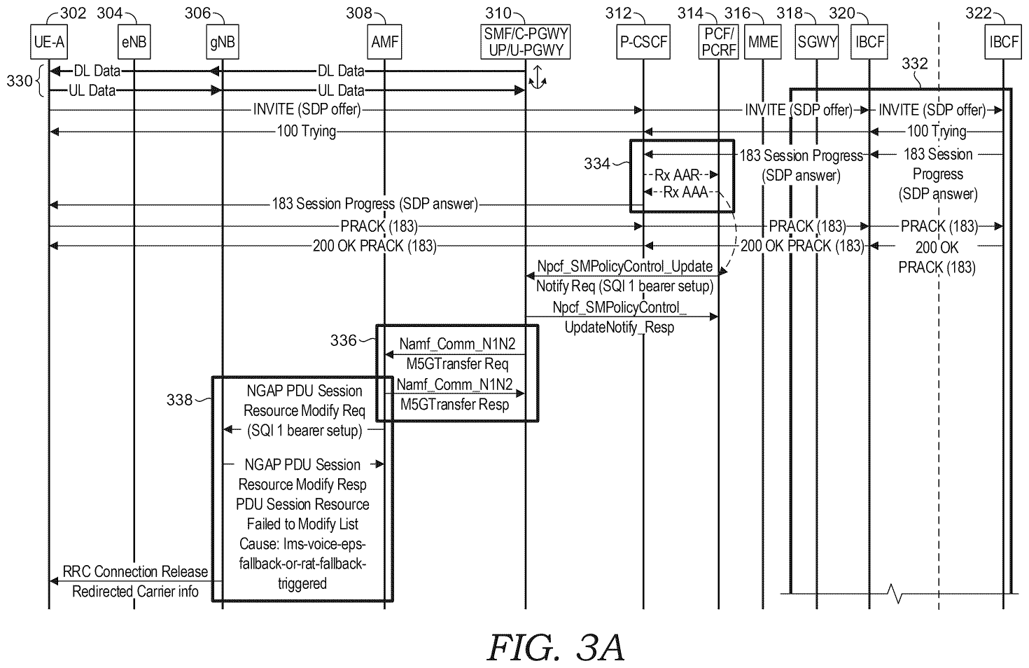

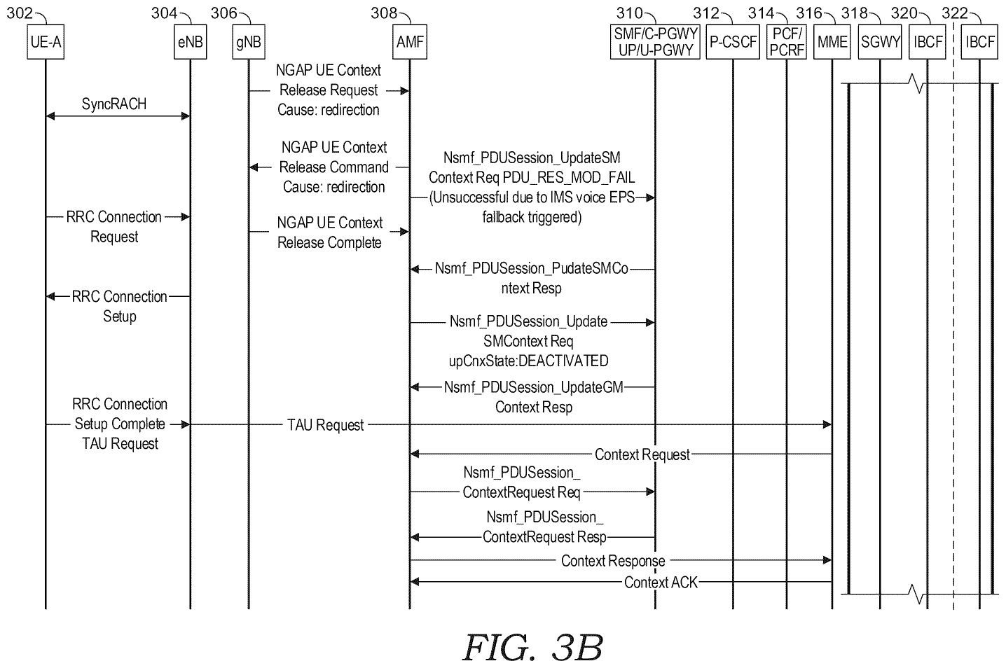

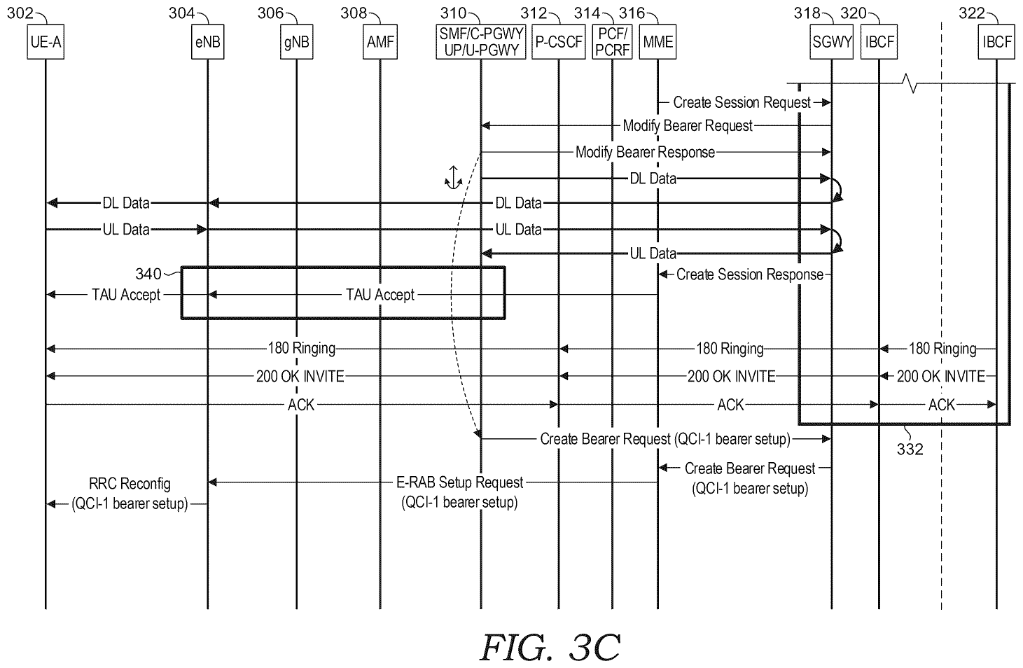

In embodiments, the network 108 may include one or more of a local area network (LAN), a wide area network (WAN), a mesh network, a hybrid network, a plurality of networks, another type of network, or one or more combinations thereof. In some embodiments, one or more components (e.g., the network node anomaly detection client 102, the network node anomaly detection engine 110, etc.) illustrated within the example operating environment 100 may communicate over the network 108 via the Internet, another public or private network, etc., or one or more combinations thereof. In some embodiments, the network 108 includes 5G standalone technology (independent of 4G technology), 5G non-standalone technology, LTE network technology, another generation network technology, 802.11x, etc., or one or more combinations thereof. For example, the network 108 can provide communication services (e.g., via a base station or access point) for user devices. In some embodiments, the network 108 may include one or more of the network components (and functionality described therein) illustrated in FIGS. 3A-3C (e.g., AMF 308, SMF/C-PGWY/UPF/U-PGWY 310, P-CSCF 312, PCF/PCRF 314, etc.). In some embodiments, the network 108 may include one or more of the network components (and functionality described therein) illustrated in the example network block diagram 200 of FIG. 2 (e.g., AMF 202, SMF 204, UPF 206, and IMS 208).

For example, referring to the example network block diagram 200 of FIG. 2, example network block diagram 200 includes AMF 202, SMF 204, UPF 206, and IP Multimedia Subsystem (IMS) 208. For example, the AMF 202 may provide mobility management functions (e.g., user device registration, user device session setup, user device handover management, etc.) associated with the voice call and user device, and may use the Network Access and Mobility Function (Namf) interface for communication and coordination with other network functions associated with the example network block diagram 200. Additionally, the AMF 202 may communicate and coordinate (e.g., via N2 interface) with an evolved Packet Data Gateway (ePDG), which may be associated with non-3GPP access networks, such as Wi-Fi. The AMF 202 may also communicate and coordinate (e.g., via N1 interface) with a user device and gNodeB (e.g., via N2 interface) for the voice call establishment.

The SMF 204 may establish and manage data sessions associated with the user device and the voice call, and enforce network policies and access controls associated with the user device and the voice call, among other things. The SMF 204 may use the Nsmf interface for communication and coordination with other network functions associated with the example network block diagram 200 for voice call establishment. Additionally, the SMF 204 may communicate with the UPF 206 using the N4 interface. For example, the UPF 206 may perform forwarding, routing, and traffic steering operations associated with the voice call based on the communications with the SMF.

The IMS 208 may communicate with the UPF 206 via the N6 interface for voice call establishment. In embodiments, the IMS 208 utilizes SIP session establishment (and modification or termination, etc.) associated with the voice call. In some embodiments, the IMS 208 includes one or more of a Media Resource Function, Conferencing Server, Messaging Server, etc. In embodiments the example network block diagram 200 is 5G standalone architecture, and the IMS 208 may support integration with one or more of LTE, Wi-Fi, Public Switched Telephone Network (PSTN), Global System for Mobile Communications (GSM), Universal Mobile Telecommunications System (UMTS), etc., or one or more combinations thereof.

Referring back to FIG. 1, in embodiments, the network node anomaly detection engine 110 may comprise computing devices (e.g., user device 700 of FIG. 7). In some embodiments, the network node anomaly detection engine 110 may be a single server, a distributed computing environment encompassing multiple computing devices located at the same physical geographical location or at different physical geographical locations, another type of server environment, etc. In embodiments, the network node anomaly detection engine 110 may comprise one or more processors, one or more electronics devices, one or more hardware devices, one or more electronics components, one or more logical circuits, one or more memories, one or more software codes, one or more firmware codes, etc., or one or more combinations thereof.

The network node anomaly detection engine 110 may access the database 120 to execute tasks associated with the network node anomaly detection machine learning model(s) 122. For example, a user—via the network node anomaly detection client 102 (e.g., via the network node anomaly detection interface 104) or another user device—may communicate a request to establish a voice call. Based on communicating the request, the network node anomaly detection engine 110 may receive a trigger associated with the voice call request. In embodiments, the trigger may correspond to an initial access procedure to connect the user device to a 5G SA network or another type of network for establishing the voice call. In embodiments, the trigger may correspond to synchronization with a base station (e.g., gNodeB, eNodeB, etc.) or another access point for establishing the voice call for the user device. In some embodiments, the trigger may correspond to user device selection of a core network for voice services (e.g., VoNR, EPSFB).

Based on the trigger associated with the voice call request, the network node anomaly detection engine 110 may utilize the SIP Invite analyzer 112, the KPI analyzer 114, and the network node identifier 116 for accessing the network node anomaly detection machine learning model(s) 122, the AMF node data 124, the UPF node data 126, the PCF node data 128, the SMF node data 130, and the P-CSCF node data of the database 120, such that the network node anomaly detection engine 110 may identify a control plane node having anomalous network node data that is causing the failure of the voice call establishment, such that the control plane node anomaly is identified based on time and regional correlations (e.g., associating particular network nodes within a particular geographical area with particular KPI measurements during particular time periods).

In some embodiments, the AMF node data 124, the UPF node data 126, the PCF node data 128, the SMF node data 130, and the P-CSCF node data may include historical data for each of these associated control plane nodes (e.g., for successfully established voice calls, for voice call establishments that failed, etc.), which may be used for training the network node anomaly detection machine learning model(s) 122. In some embodiments, the network node anomaly detection machine learning model(s) 122 may include a density function machine learning model. By way of example, the density function machine learning model may be a Kernel Density Estimation that is a non-parametric method used to estimate the probability density function of a random variable associated with each of the AMF node data 124, the UPF node data 126, the PCF node data 128, the SMF node data 130, and the P-CSCF node data. As another example, the density function machine learning model may be a Gaussian Mixture Model representing a probability distribution as a weighted sum of multiple Gaussian distributions, wherein each component of the mixture model represents a cluster or mode in one or more of the AMF node data 124, the UPF node data 126, the PCF node data 128, the SMF node data 130, and the P-CSCF node data. In some embodiments, the density function machine learning model may be a deep generative model (e.g., a variational autoencoder, a generative adversarial network, etc.), a neural autoregressive model (e.g., an autoregressive moving average mode, an autoregressive integrated moving average mode, an autoregressive neural network, etc.), a kernel density generative adversarial network, etc., or one or more combinations thereof.

In some embodiments, the AMF node data 124 corresponds to AMF 202 described in FIG. 2 or the AMF 308 of FIGS. 3A-3C (e.g., associated with the transmissions 330, 336, and 338 of FIG. 3A and 340 of FIG. 3C). In some embodiments, the UPF node data 126 corresponds to UPF 206 of FIG. 2 or the SMF/C-PGWY/UPF/U-PGWY 310 of FIGS. 3A-3C (e.g., associated with the transmissions 330 and 336 of FIG. 3A and 340 of FIG. 3C). In some embodiments, the PCF node data 128 corresponds to PCF/PCRF 314 of FIGS. 3A-3C (e.g., associated with the transmissions 334 of FIG. 3A). In some embodiments, the SMF node data 130 corresponds to SMF 204 of FIG. 2 or SMF/C-PGWY/UPF/U-PGWY 310 of FIGS. 3A-3C (e.g., associated with the transmissions 330 and 336 of FIG. 3A and 340 of FIG. 3C). In some embodiments, the P-CSCF node data corresponds to P-CSCF 312 of FIGS. 3A-3C (e.g., associated with transmissions 334 of FIG. 3A).

In embodiments, the network node anomaly detection machine learning model(s) 122 may be provided network node data associated with the voice call establishment (e.g., end-to-end voice call establishment call flow for VoNR in a 5G Stand Alone Network). For example, the network node data may include network node data from AMF node data 124, UPF node data 126, PCF node data 128, SMF node data 130, and P-CSCF node data, as the voice call establishment is being performed across the network 108 (e.g., via the network components illustrated in FIGS. 2-3).

As another example, the network node anomaly detection engine 110 may utilize the SIP Invite analyzer 112 and the KPI analyzer 114 for providing network node data to the network node anomaly detection machine learning model(s) 122, so that the network node identifier 116 can identify a control plane node (e.g., AMF 202 or UPF 206) that has anomalous network node data. To illustrate, the network node anomaly detection engine 110 may utilize the SIP Invite analyzer 112 to analyze SIP invite network node data (e.g., associated with the transmissions 332 of FIGS. 3A-3C) and may utilize the KPI analyzer 114 to analyze a plurality of KPIs (e.g., associated with the transmissions 330, 334, 336 and 338 of FIG. 3A, and 340 of FIG. 3C) for identification of a network node having anomalous network node data.

For example, AMF node data 124 may be provided to the network node anomaly detection machine learning model(s) 122 after initiation of an end-to-end Voice Call Establishment call flow. In embodiments, based on the trigger associated with the voice call establishment, the user device may initiate a VoNR registration process with the network 108 (e.g., a 5G core network). In embodiments, based on the trigger associated with the voice call establishment, the user device may initiate a registration request to the network 108 (e.g., AMF 308 of FIGS. 3A-3C) for EPSFB.

Referring to the transmissions 330 of FIG. 3A, the SMF/C-PGWY/UPF/U-PGWY 310 FIGS. 3A may transmit downlink data associated with the voice call establishment to the AMF 308, from the AMF 308 to the gNodeB 306, and from the gNodeB 306 to UE 302. In embodiments, the AMF node data 124 of FIG. 1 provided to the network node anomaly detection machine learning model(s) 122, after initiation of an end-to-end Voice Call Establishment call flow, may be associated with the downlink received (e.g., and processed) by AMF 308 of FIG. 3A. Additionally, the AMF node data 124 of FIG. 1 provided to the network node anomaly detection machine learning model(s) 122, after initiation of an end-to-end Voice Call Establishment call flow, may be associated with the uplink corresponding to the transmissions 330 of FIG. 3A received by AMF 308 from the gNodeB 306 and transmitted to the SMF/C-PGWY/UPF/U-PGWY 310.

In some embodiments, AMF registration network node data (e.g., associated with AMF 308 of FIGS. 3A-3C) of the AMF node data 124 of FIG. 1 may be provided to the network node anomaly detection machine learning model(s) 122 after initiation of an end-to-end Voice Call Establishment call flow. In embodiments, the AMF registration network node data may include a user device identifier, user device capability information (e.g., bandwidth requirements), user device location information, destination information, security parameters, QoS requirements for the voice call (e.g., latency and packet loss), voice call session setup preferences, etc. In some embodiments, the AMF registration network node data may include authentication data associated with the AMF verification of the voice call for the user device, AMF resources for allocation for the voice call, bandwidth reservation for the voice call, radio resources assigned for the voice call, etc.

In some embodiments, after providing the AMF registration network node data to the network node anomaly detection machine learning model(s) 122, AMF Packet Data Unit (PDU) establishment network node data (e.g., associated with the AMF 202 of FIG. 2, the AMF 308 of FIGS. 3A-3C, the AMF node data 124 of FIG. 1) may be provided to the network node anomaly detection machine learning model(s) 122. For example, the AMF PDU establishment network node data may correspond to a data path between the user device and the 5G core network for carrying the voice call. As another example, the AMF PDU establishment network node data may include a PDU session type, a Session and Service Continuity (SSC) mode, a 5G Session Management (5GSM) capability, a maximum number of supported packet filters, a request type, extended protocol configuration options, etc.

In some embodiments, after providing the AMF PDU establishment network node data, User Plane Function (UPF) Session Initiation Protocol (SIP) invite network node data (e.g., associated with UPF 206 of FIG. 2, SMF/C-PGWY/UPF/U-PGWY 310 of FIGS. 3A-3C, UPF node data 126 of FIG. 1) may be provided to the network node anomaly detection machine learning model(s) 122 during the end-to-end Voice Call Establishment call flow. In some embodiments, the UPF SIP invite network node data may be analyzed by SIP invite analyzer 112 based on the transmissions 332 of FIGS. 3A-3C. For example, the SIP invite analyzer 112 of FIG. 1 may analyze the UPF SIP invite network node data, based on the SIP invite transmissions associated with the serving gateway (SGWY) 318, the Interconnection Border Control Function (IBCF) 320, the IBCF 322 associated with another provider, and the transmissions 332 of FIGS. 3A-3C.

In some embodiments, the UPF SIP invite network node data may correspond to a PDU session between the SGWY 318 of FIGS. 3A-3C and the IBCF 320 for facilitating the transmission voice packets across different network domains (e.g., with the IBCF 322 of FIGS. 3A-3C) to maintain an end-to-end connectivity for establishing the voice call. In some embodiments, the UPF SIP invite network node data may correspond to SGWY 318 of FIGS. 3A-3C coordination with IMS (e.g., the IMS 208 of FIG. 2) for routing the voice call. In some embodiments, the UPF SIP invite network node data may correspond to a 183 session progress interim response message from the IBCF 322 of FIGS. 3A-3C based on the IBCF 320 and the IBCF 322 receiving the SIP invite. As another example, the UPF SIP invite network node data may correspond to an SIP 180 ringing and feedback associated with the IBCF 322 of FIGS. 3A-3C, an SIP 200 OK response, as well as other transmissions between the IBCF 320 and the IBCF 322.

In some embodiments, after providing the UPF SIP invite network node data, Policy Control Function (PCF) Authorization Authentication Request (AAR) and authentication network node data (e.g., Authentication, Authorization and Accounting (AAA)) may be provided to the network node anomaly detection machine learning model(s) 122 during the end-to-end Voice Call Establishment call flow. In embodiments, the PCF AAR and AAA network node data may be associated with the PCF node data 128 of FIG. 1 and a PCF control node (e.g., PCF/PCRF 314 of FIGS. 3A-3C). In embodiments, the PCF AAR and AAA network node data may be associated with the P-CSCF node data 132 of FIG. 1 and a P-CSCF control node (e.g., P-CSCF 312 of FIGS. 3A-3C).

For example, the PCF AAR network node data may include a policy determination, the network conditions in which that policy decision was determined, subscription profile data associated with the voice call, QoS and resource allocation (e.g., associated with VoNR establishment or EPSFB establishment and provided via AAR), etc. As another example, the PCF AAA network node data may include authentication for the use device accessing the voice call (e.g., over 5G core network for VoNR or LTE for EPSFB), subscription profile data used for authenticating the user device for the voice call, subscription profile data associated with usage details and call duration for the voice call, etc. In embodiments, the PCF AAR and AAA network node data may correspond to the 334 transmission of FIG. 3A associated with the P-CSCF 312 and the PCF/PCRF 314 of FIG. 3A.

In some embodiments, after providing the PCF AAR and AAA network node data, Session Management Function (SMF) network node data (e.g., SMF node data 130 of FIG. 1 corresponding to communications between an SMF control plane node (e.g., SMF 204 of FIG. 2, SMF/C-PGWY/UPF/U-PGWY 310 of FIGS. 3A-3C) and AMF control plane node (e.g., AMF 202 of FIG. 2, AMF 308 of FIGS. 3A-3C)) may be provided to the to the network node anomaly detection machine learning model(s) 122 of FIG. 1 during the end-to-end Voice Call Establishment call flow. In some embodiments, the SMF network node data may include the transmission 336 of FIG. 3A. In some embodiments, the SMF network node data may correspond to the N1N2 message transfer between the SMF/C-PGWY/UPF/U-PGWY 310 and AMF 308 of FIGS. 3A-3C. For instance, the N1N2 message transfer may be associated with the Namf interface. In some embodiments, the N1N2 message transfer may be based on the SMF control plane node (e.g., SMF 204 of FIG. 2) communicating with the UPF control plane node (e.g., UPF 206 of FIG. 2). For example, the N1N2 message transfer may correspond to SMF control plane node and UPF control plane node communications for the establishment and management of bearer contexts, configuration of QoS parameters, management of traffic routing for VoNR traffic or EPSFB traffic, etc.

In some embodiments, after providing the SMF network node data, AMF PDU session resource modification network node data (e.g., AMF node data 124 of FIG. 1) may be provided to the to the network node anomaly detection machine learning model(s) 122 of FIG. 1 during the end-to-end Voice Call Establishment call flow. In some embodiments, the AMF PDU session resource modification network node data may correspond to transmissions 338 of FIG. 3A. For example, the AMF PDU session resource modification network node data may correspond to the communications between AMF 308 and gNodeB 306 of FIGS. 3A-3C, after the transmission 336 of FIG. 3A. In some embodiments, the transmissions 338 of FIG. 3A may include Next Generation Application Protocol (NGAP) PDU session resource modifications associated with 5G QoS Identifier (5QI) bearer setup and the corresponding response from the gNodeB 306 of FIGS. 3A-3C.

After providing the AMF PDU session resource modification network node data, AMF Tracking Area Update (TAU) network node data (e.g., AMF node data 124 of FIG. 1) may be provided to the to the network node anomaly detection machine learning model(s) 122 of FIG. 1 during the end-to-end Voice Call Establishment call flow. In some embodiments, the AMF TAU network node data may correspond to transmissions 340 of FIG. 3C. In some embodiments, the KPI analyzer 114 of FIG. 1 may analyze the TAU accept, initially transmitted by MME 316, during the transmissions associated with the TAU accept from the SMF/C-PGWY/UPF/U-PGWY 310, to the AMF 308, and to the gNodeB 306 or eNodeB 304. In some embodiments, the KPI analyzer 114 of FIG. 1 may analyze the transmissions 340 of FIG. 3C after analyzing the AMF registration network node data, the AMF PDU establishment network node data, the PCF AAR and AAA network node data, the SMF network node data associated with the transmission 336 of FIG. 3A, and the AMF PDU session resource modification network node data corresponding to the transmissions 338 of FIG. 3A.

After providing the AMF TAU network node data, AMF Next Generation Application Protocol (NGAP) reset network node data (e.g., AMF node data 124 of FIG. 1) may be provided to the to the network node anomaly detection machine learning model(s) 122 of FIG. 1 during the end-to-end Voice Call Establishment call flow. In embodiments, the AMF NGAP reset network node data may correspond to AMF control plane node (e.g., AMF 308 of FIGS. 3A-3C) communications with the radio access network (e.g., gNodeB 306 or eNodeB 304 of FIGS. 3A-3C) associated with a signal error, a resource conflict, an effect on the continuity of the end-to-end establishment of the voice call, etc. In some embodiments, after providing the AMF NGAP reset network node data, AMF paging network node data may be provided to the to the network node anomaly detection machine learning model(s) 122 of FIG. 1 during the end-to-end Voice Call Establishment call flow. In embodiments, the AMF paging network node data may correspond to the AMF control plane node paging the user device upon the user device associated with the VoNR voice call transitioning to an idle mode or experiencing an interruption from the network 108. In some embodiments, the AMF paging network node data may correspond to the AMF control plane node paging the user device via an LTE core network (e.g., an evolved packet core) over an LTE air interface within the coverage area associated with the user device and the EPSFB voice call. In some embodiments, the AMF paging network node data may correspond to paging responses from the user device.

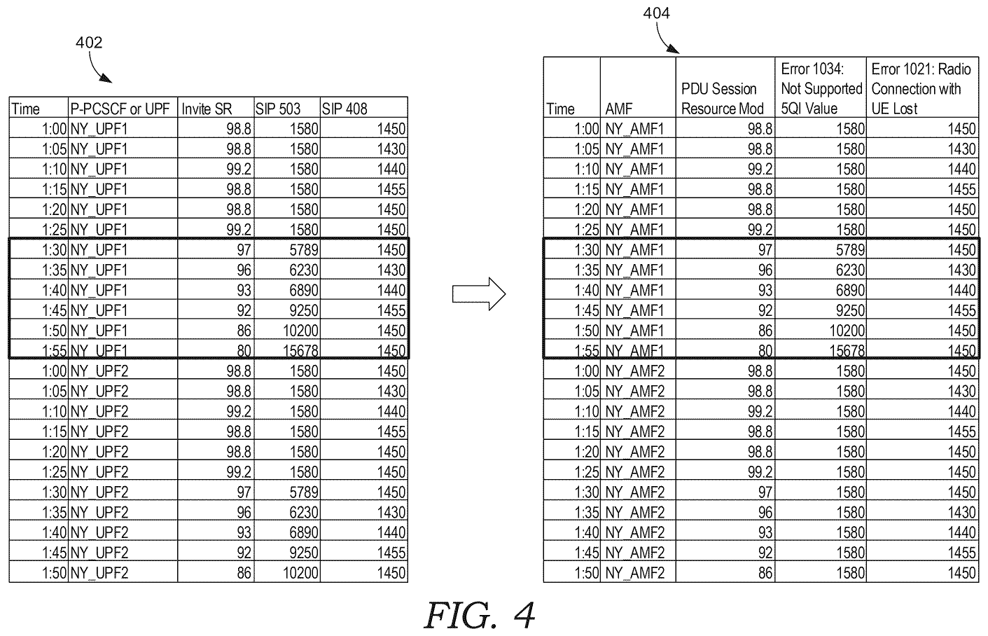

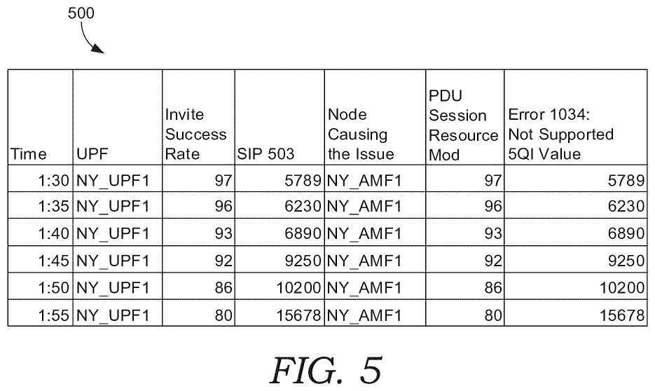

In embodiments, the network node identifier 116 may identify one or more control plane nodes (e.g., the AMF 202 of FIG. 2 and the UPF 206 of FIG. 2) for providing an indication of the control plane node (e.g., as illustrated in FIG. 2 with respect to the AMF 202 of FIG. 2 and the UPF 206, as illustrated in table 500 of FIG. 5) based on the SIP invite analyzer 112 analyzing the UPF SIP invite network node data (e.g., associated with the transmissions 332 of FIGS. 3A-3C) and based on the KPI analyzer 114 analyzing the plurality of KPIs (e.g., one or more of the AMF registration network node data, the AMF PDU establishment network node data, the PCF AAR and AAA network node data, the SMF N1N2 message transfer network node data, the AMF PDU session resource modification network node data, the AMF TAU network node data, the AMF NGAP reset network node data, and the AMF paging network node data). As another example, the network node identifier 116 may identify one or more control plane nodes for providing an indication of the control plane node (e.g., the AMF control plane node identified in table 404 of FIG. 4) based on the SIP invite analyzer 112 analyzing the UPF SIP invite network node data and based on the KPI analyzer 114 analyzing the plurality of KPIs (e.g., associated with the transmissions 330, 334, 336, 338, and 340 of FIGS. 3A-3C).

In some embodiments, the network node anomaly detection engine 110 may provide an indication (e.g., to the network node anomaly detection client 102 via the network node anomaly detection interface 104) of one or more control plane nodes of a plurality of network nodes having anomalous network node data. For example, in some embodiments, the indication of the one or more control plane nodes having anomalous network node data may correspond to table 404 of FIG. 4 or table 500 of FIG. 5. For example, table 404 of FIG. 4 identifies the AMF control plane node having anomalous network node data. As another example, the table 500 of FIG. 5 identifies the AMF control plane node having anomalous network node data.

With respect to table 402 of FIG. 4, the SIP 503 network node data (e.g., monitored by the network node anomaly detection engine 110 of FIG. 1 via the SIP invite analyzer 112 analyzing the UPF SIP invite network node data) may begin to increase (e.g., increase over a threshold or increase over a threshold rate) during a particular time or time range for a particular geographical region, causing the analysis of SIP invite network node data and KPIs (e.g., via the SIP invite analyzer 112 and the KPI analyzer 114 of FIG. 1) within the particular geographical region. Continuing this example, the control plane node having anomalous network node data for this particular geographical region may be identified (e.g., via the network node identifier 116 of FIG. 1) based on the analysis of SIP invite network node data and KPIs in response to the detected SIP 503 network node data increase. Based on identifying the control plane node having the anomalous network node data, table 404 of FIG. 4 may be provided as an indication (e.g., to the network node anomaly detection client 102 of FIG. 1 via the network node anomaly detection interface 104).

### Example Flowchart

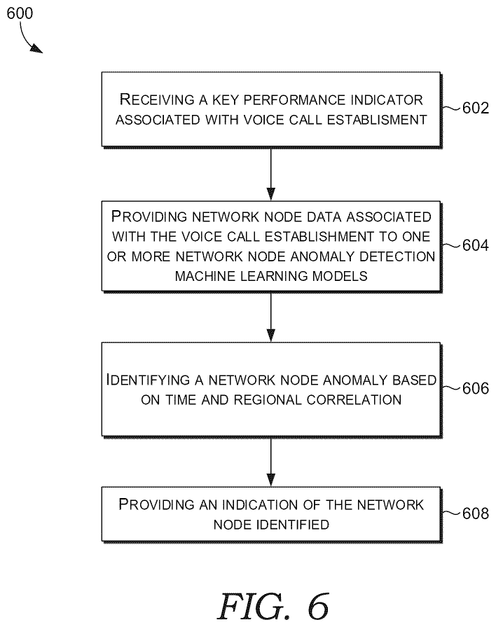

Having described the example embodiments discussed above, an example flowchart is described below with respect to FIG. 6. Example flowchart 600 begins at step 602 with receiving a key performance indicator associated with voice call establishment (e.g., for a user device) for network node anomaly detection (e.g., by the network node anomaly detection engine 110 of FIG. 1). In some embodiments, the trigger (e.g., KPI) may correspond to the user device initiating an AMF registration via a 5G core network or LTE network. In some embodiments, the voice call establishment corresponds to Voice over New Radio (VoNR). In some embodiments, the voice call establishment corresponds to Evolved Packet System Fallback (EPSFB).

Step 604 comprises providing network node data associated with the voice call establishment to one or more network node anomaly detection machine learning models. In embodiments, the network node data may correspond to the AMF node data 124, UPF node data 126, PCF node data 128, SMF node data 130, and P-CSCF node data 132 of FIG. 1. In embodiments, the network node data may correspond to the transmission 332 of FIGS. 3A-3C, transmissions 334 and 336 of FIG. 3A, 338, and 340 of FIG. 3C. In some embodiments, the one or more network node anomaly detection machine learning models may correspond to the network node anomaly detection machine learning model(s) 122 of FIG. 1. In some embodiments, the one or more network node anomaly detection machine learning models may include a density function machine learning model.

In some embodiments, providing the network node data to the one or more network node anomaly detection machine learning models may comprise providing Access and Mobility Management Function (AMF) registration network node data (e.g., associated with an AMF control plane node and a user device for the voice call) to the one or more network node anomaly detection machine learning models. In some embodiments, providing the network node data may comprise providing AMF Packet Data Unit (PDU) establishment network node data associated with the AMF control plane node to the one or more network node anomaly detection machine learning models (e.g., after providing the AMF registration network node data to the one or more network node anomaly detection machine learning models).

In some embodiments, providing the network node data may comprise providing User Plane Function (UPF) Session Initiation Protocol (SIP) invite network node data associated with a UPF control plane node to the one or more network node anomaly detection machine learning models (e.g., after providing the AMF PDU establishment network node data to the one or more network node anomaly detection machine learning models). In some embodiments, providing the network node data may comprise providing Policy Control Function (PCF) Authorization Authentication Request (AAR) and authentication network node data to the one or more network node anomaly detection machine learning models (e.g., after providing the UPF SIP invite network node data).

In some embodiments, providing the network node data may comprise providing Session Management Function (SMF) network node data (e.g., for the VoNR or EPSFB) to the one or more network node anomaly detection machine learning models (e.g., after providing the PCF AAR and authentication network node data). In some embodiments, the SMF network node data may correspond to communications between an SMF control plane node and each of the AMF control plane node and the UPF control plane node. In some embodiments, providing the network node data may comprise providing AMF PDU session resource modification network node data to the one or more network node anomaly detection machine learning models (e.g., after providing the SMF network node data).

Step 606 comprises identifying a network node anomaly (e.g., based on providing the network node data to the one or more network node anomaly detection machine learning models) and based on time and regional correlation. In some embodiments, the network node anomaly is identified based on having anomalous network node data for a particular network node in a particular geographical region. In some embodiments, a control plane network node having the anomalous network node data is identified using the network node identifier 116 of FIG. 1. In some embodiments, a control plane network node having the anomalous network node data is identified based on the SIP invite analyzer 112 of FIG. 1 analyzing SIP invite network node data (e.g., associated with the transmissions 332 of FIGS. 3A-3C) and based on the KPI analyzer 114 of FIG. 1 analyzing the plurality of KPIs (e.g., one or more of the AMF registration network node data, the AMF PDU establishment network node data, the PCF AAR and AAA network node data, the SMF N1N2 message transfer network node data, the AMF PDU session resource modification network node data, the AMF TAU network node data, the AMF NGAP reset network node data, and the AMF paging network node data).

Step 608 comprises providing an indication of the network node anomaly identified. In some embodiments, the indication is provided to the network node anomaly detection client 102 of FIG. 1 via the network node anomaly detection interface 104 of FIG. 1. In some embodiments, the indication is provided to the user device 700 of FIG. 7 via the presentation component(s) 708 and the network node anomaly detection associated display 708A. In some embodiments, the indication corresponds to table 404 of FIG. 4. In some embodiments, the indication corresponds to table 500 of FIG. 5. In some embodiments, information as to why the voice call (e.g., the VoNR or EPSFB) was not established may be provided (e.g., via the presentation component(s) 708 and the network node anomaly detection associated display 708A of FIG. 7, via the network node anomaly detection interface 104 of FIG. 1). In some embodiments, the information as to why the voice call (e.g., the VoNR or EPSFB) was not established may correspond to the PDU session resource failing to modify the list associated with the NGAP PDU session. In some embodiments, the information as to why the voice call (e.g., the VoNR or EPSFB) was not established may correspond to a redirection associated with a NGAP UE context release request. In some embodiments, the information as to why the voice call (e.g., the VoNR or EPSFB) was not established may correspond to Nsmf PDU session and a filed resource modification, wherein the SMF control plane node is holding the response until a handover time is triggered. In some embodiments, the information as to why the voice call (e.g., the VoNR or EPSFB) was not established may correspond to an MME to HSS update location.

### Example User Device

Referring now to FIG. 7, a diagram is depicted of an example user device suitable for use in implementations of the present disclosure. In particular, the example computer environment is shown and designated generally as user device 700. User device 700 is but one example of a suitable computing environment and is not intended to suggest any limitation as to the scope of use or functionality of the invention. Neither should user device 700 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 7, user device 700 includes bus 702 that directly or indirectly couples the following devices: memory 704, one or more processors 706, one or more presentation components 708, input/output (I/O) ports 710, I/O components 712, power supply, 714 and radio(s) 716. The memory 704 may include network node anomaly detection associated operating instructions 704A, which may be executed by the processor(s) 706 to perform network node anomaly detection associated operations 706A. The one or more presentation components 708 may include network node anomaly detection associated display 708A (e.g., for displaying indications associated with operations of the network node anomaly detection engine 110 of FIG. 1 of FIG. 1).

Although the components of FIG. 7 are shown with lines for the sake of clarity, in reality, delineating various components is not so clear, and metaphorically, the lines would more accurately be grey and fuzzy. For example, one may consider a presentation component, such as a display device to be one of I/O components 712. As another example, processors, such as one or more processors 706, have memory. The present disclosure hereof recognizes that such is the nature of the art, and reiterates that FIG. 7 is merely illustrative of an example computing environment for a user device that may be used in connection with one or more implementations of the present disclosure. Additionally, distinction is not made between such categories as “workstation,” “server,” “laptop,” “handheld device,” etc., as all are contemplated within the scope of FIG. 7 and refer to “computer” or “computing device.” In yet another example, bus 702 may represent what may be one or more busses (such as an address bus, data bus, or combination thereof).

User device 700 typically includes a variety of computer-readable media. Computer-readable media may be any available media that may be accessed by user device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 704 includes computer-storage media in the form of volatile and/or nonvolatile memory. Memory 704 may be removable, non-removable, or a combination thereof. Examples of memory 704 may include solid-state memory, hard drives, optical-disc drives, etc., or one or more combinations thereof.

User device 700 also includes one or more processors 706 that read data from various entities, such as bus 702, memory 704, or I/O components 712. Examples of one or more processors 706 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors, or one or more combinations thereof.

One or more presentation components 708 may present (e.g., to a person or other device) data indications. Examples of the one or more presentation components 708 may include a display device, speaker, printing component, vibrating component, etc. I/O ports 710 may allow user device 700 to be logically coupled to I/O components 712 or other devices. In some embodiments, only a portion of a plurality of I/O components 712 may be built into user device 700. Illustrative I/O components 712 may include a microphone, joystick, game pad, satellite dish, scanner, printer, wireless device, etc., or one or more combinations thereof. In some embodiments, the one or more presentation components 708 may provide an indication (e.g., via the display or vibrating component) of the network node having the anomalous network node data.

Radio 716 may represent a radio that facilitates communication with a wireless telecommunications network. Illustrative wireless telecommunications technologies may include CDMA, GPRS, TDMA, GSM, and the like. Radio 716 might additionally or alternatively facilitate other types of wireless communications including Wi-Fi, WiMAX, LTE, or other VoIP communications. As can be appreciated, in various embodiments, radio 716 may be configured to support multiple technologies and/or multiple radios may be utilized to support multiple technologies.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for network node anomaly detection, the system comprising:
one or more processors; and
computer memory storing computer-usable instructions that, when executed by the one or more processors, cause the one or more processors to perform operations comprising:
receiving a Key Performance Indicator (KPI) associated with voice call establishment for the network node anomaly detection;
providing network node data associated with the voice call establishment to one or more network node anomaly detection machine learning models;
based on the KPI and providing the network node data to the one or more network node anomaly detection machine learning modes, identifying a control plane node anomaly based on time and regional correlation; and
providing an indication of the control plane node anomaly.

2. The system according to claim 1, wherein the one or more network node anomaly detection machine learning models includes a density function machine learning model.

3. The system according to claim 1, wherein providing the network node data to the one or more network node anomaly detection machine learning models comprises:
providing Access and Mobility Management Function (AMF) registration network node KPI data associated with an AMF control plane node to the one or more network node anomaly detection machine learning models; and
after providing the AMF registration network node data to the one or more network node anomaly detection machine learning models, providing AMF Packet Data Unit (PDU) establishment network node data associated with the AMF control plane node to the one or more network node anomaly detection machine learning models.

4. The system according to claim 3, wherein providing the network node data to the one or more network node anomaly detection machine learning models comprises:
after providing the AMF PDU establishment network node data to the one or more network node anomaly detection machine learning models, providing User Plane Function (UPF) Session Initiation Protocol (SIP) invite network node data associated with a UPF control plane node to the one or more network node anomaly detection machine learning models; and
after providing the UPF SIP invite network node data, providing Policy Control Function (PCF) Authentication Authorization Request (AAR) and Authentication, Authorization and Accounting (AAA) network node data to the one or more network node anomaly detection machine learning models.

5. The system according to claim 4, wherein providing the network node data to the one or more network node anomaly detection machine learning models comprises:
after providing the PCF AAR and AAA network node data, providing Session Management Function (SMF) network node data for the VoNR to the one or more network node anomaly detection machine learning models, wherein the SMF network node data corresponds to communications between an SMF control plane node and each of the AMF control plane node and the UPF control plane node.

6. The system according to claim 5, wherein providing the network node data to the one or more network node anomaly detection machine learning models comprises providing AMF PDU session resource modification network node data to the one or more network node anomaly detection machine learning models after providing the SMF network node data.

7. The system according to claim 1, wherein providing the network node data to the one or more network node anomaly detection machine learning models comprises:
providing Access and Mobility Management Function (AMF) Packet Data Unit (PDU) establishment network node data, associated with an AMF control plane node and Evolved Packet System Fallback (EPSFB), to the one or more network node anomaly detection machine learning models; and
after providing the AMF PDU establishment network node data, providing User Plane Function (UPF) Session Initiation Protocol (SIP) invite network node data associated with the EPSFB to the one or more network node anomaly detection machine learning models.

8. A system according to claim 7, wherein providing the network node data to the one or more network node anomaly detection machine learning models comprises:
after providing the UPF SIP invite network node data associated with the EPSFB, providing AMF PDU session resource modification network node data associated with the EPSFB to the one or more network node anomaly detection machine learning models;
after providing the AMF PDU session resource modification network node data, providing AMF Next Generation Application Protocol (NGAP) reset network node data to the one or more network node anomaly detection machine learning models; and
after providing the AMF NGAP reset network node data, providing AMF paging network node data.

9. A system according to claim 1, wherein the indication of the control plane node anomaly is provided in near real-time, wherein the voice call establishment corresponds to Voice over New Radio (VoNR), and wherein the operations further comprise providing information as to why the VoNR was not established.

10. A method for network node anomaly detection, the method comprising:
receiving, from a user device and over a network, a trigger associated with establishing a voice call for the network node anomaly detection;
based on the trigger, providing network node data, associated with the voice call and a plurality of network nodes of the network, to one or more network node anomaly detection machine learning models;
identifying, using the one or more network node anomaly detection machine learning models, a control plane node of the plurality of network nodes having anomalous network node data; and
providing an indication of the control plane node.

11. The method according to claim 10, wherein the network node data provided to the to the one or more network node anomaly detection machine learning models includes a plurality of key performance indicators corresponding to an Access and Mobility Management Function (AMF) registration, AMF Packet Data Unit (PDU) establishment, and a User Plane Function (UPF) Session Initiation Protocol (SIP) invite.

12. The method according to claim 10, wherein the network node data provided to the to the one or more network node anomaly detection machine learning models includes a plurality of key performance indicators corresponding to a User Plane Function (UPF) Session Initiation Protocol (SIP) invite and Session Management Function (SMF) network node data corresponding to communications between an SMF control plane node and each of an Access and Mobility Management Function (AMF) control plane node and a UPF control plane node.

13. The method according to claim 12, wherein the one or more network node anomaly detection machine learning models includes a density function machine learning model, and wherein the plurality of key performance indicators include AMF Packet Data Unit (PDU) session resource modification network node data and AMF Next Generation Application Protocol (NGAP) reset network node data.

14. The method according to claim 13, wherein the voice call is Voice over New Radio (VoNR), wherein the plurality of key performance indicators include AMF Tracking Area Update (TAU) network node data for the AMF control plane node, and wherein the method further comprises providing information as to why the VoNR was not established.

15. One or more computer storage media having computer-executable instructions embodied thereon, that when executed by at least one processor, cause the at least one processor to perform a method comprising:
receiving a trigger associated with voice call establishment;
based on the trigger, providing network node data associated with the voice call establishment to one or more network node anomaly detection machine learning models;
identifying a control plane node having anomalous network node data based on providing the network node data to the one or more network node anomaly detection machine learning models; and
causing to provide an indication of the control plane node.

16. The one or more computer storage media of claim 15, wherein providing the network node data associated with the voice call establishment to the one or more network node anomaly detection machine learning models comprises:
providing User Plane Function (UPF) Session Initiation Protocol (SIP) invite network node data associated with a UPF control plane node to the one or more network node anomaly detection machine learning models.

17. The one or more computer storage media of claim 16, wherein providing the network node data associated with the voice call establishment to the one or more network node anomaly detection machine learning models comprises:
after providing the UPF SIP invite network node data, providing Policy Control Function (PCF) network node data associated with a PCF control plane node to the one or more network node anomaly detection machine learning models.

18. The one or more computer storage media of claim 16, wherein providing the network node data associated with the voice call establishment to the one or more network node anomaly detection machine learning models comprises:
after providing the UPF SIP invite network node data, providing Session Management Function (SMF) network node data for the voice call establishment to the one or more network node anomaly detection machine learning models, wherein the SMF network node data corresponds to communications between an SMF control plane node and each of an Access and Mobility Management Function (AMF) control plane node and the UPF control plane node.

19. The one or more computer storage media of claim 16, wherein providing the network node data associated with the voice call establishment to the one or more network node anomaly detection machine learning models comprises:
after providing the UPF SIP invite network node data, providing Access and Mobility Management Function (AMF) Packet Data Unit PDU session resource modification network node data associated with an AMF control plane node to the one or more network node anomaly detection machine learning models.

20. The one or more computer storage media of claim 16, wherein the providing the network node data associated with the voice call establishment to the one or more network node anomaly detection machine learning models comprises:
after providing the UPF SIP invite network node data, providing Access and Mobility Management Function (AMF) Tracking Area Update (TAU) network node data for an AMF control plane node to the one or more network node anomaly detection machine learning models.
